(19) United States
(12) Patent Application Publication
(10) Pub. No.: US 2019/0344474 A1
(43) Pub. Date: Nov. 14, 2019

(54) METHOD AND APPARATUS FOR PRODUCING CONCRETE

(71) Applicant: EBED Holdings Inc., Baden (CA)

(72) Inventor: Walter J. Bauer, Baden (CA)

(21) Appl. No.: 16/335,525

(22) PCT Filed: Sep. 28, 2017
(86) PCT No.: PCT/CA2017/051143

§ 371 Date: Mar. 21, 2019

Related U.S. Application Data
(60) Provisional application No. 62/400,918, filed on Sep. 28, 2016.
(60) Provisional application No. 62/488,133, filed on Apr. 21, 2017.

(51) Int. Cl. B28C 5/38; B28C 5/02; B28C 7/12; B01F 3/04; B01F 5/06; C04B 38/10; C04B 40/00

(52) U.S. Cl. CPC B28C 5/388; B28C 5/02; B28C 7/126; B01F 2215/0047; B01F 5/0606; C04B 38/103; C04B 40/0042; B01F 3/0446

(57) ABSTRACT

The disclosure is directed at a method, system and apparatus for producing concrete with a nanobubble solution. A nanobubble solution, such as nanobubble water, is produced and then added as an ingredient during the production of concrete to produce an improved concrete.

### CROSS-REFERENCE TO OTHER APPLICATIONS

This is a formal application based on and claiming the benefit of U.S. Provisional Application No. 62/400,918 filed Sep. 28, 2016 and U.S. Provisional Application No. 62/488,133 filed Apr. 21, 2017 which are hereby incorporated by reference.

### TECHNICAL FIELD

The disclosure is generally directed at concrete and more specifically is directed at a method and apparatus for producing concrete.

### BACKGROUND

One of the most versatile building materials that is used in the construction industry is concrete. Concrete can be used in building foundations, driveways and walls along with other well-known applications. The use of concrete is preferred due to its diversity and availability. It is typically easy to prepare and can be molded into various shapes and forms.

The ingredients used to form concrete generally include cement, water, aggregates, admixtures, fibers and reinforcements. The proportions of each ingredient differs with each concrete mixture based on the requirements of the concrete, such as, but not limited to strength. As concrete is such a prevalent and ubiquitous material, methods of production are consistently being improved. Methods and systems directed at improving concrete quality and characteristics are also being developed.

Therefore, there is provided a novel method and apparatus for producing concrete.

### SUMMARY

The disclosure is directed at a method, system and apparatus for producing concrete. The method described provides a concrete which has advantages over conventional concrete (as it is currently being produced).

In one aspect of the disclosure, there is provided a method of producing concrete by using a nanobubble solution, such as a nanobubble water, instead of regular water during the production process. By generating a nanobubble water and substituting this into the concrete production process, improvements to the resultant concrete are realized.

For example, use of the nanobubble water in the production of concrete reduces the curing time for the concrete. Also, the use of nanobubble water provides a concrete that has a reduced number of air bubbles. In another example, the concrete being produced with the nanobubble water shrinks rather than expands while it is curing.

The method includes mixing nanobubble water and sand to produce a slurry and then adding gravel and more nanobubble water and mixing this until the mixture is at a somewhat uniform consistency. Cement can then be added and the entire mixture mixed until it is ready for placement, conditioning and curing.

In one aspect of the disclosure, there is provided a method of producing concrete including producing a nanobubble solution; mixing the nanobubble solution with sand, gravel and cement to produce a concrete mixture; and curing the concrete mixture.

In another aspect, producing a nanobubble solution includes passing a liquid though a nanobubble solution producing apparatus. In a further aspect, the liquid is water. In another aspect, producing the nanobubble solution includes passing the liquid through a nanobubble generator. In yet another aspect, producing the nanobubble solution further includes filtering the liquid prior to passing the liquid solution through the nanobubble generator. In yet a further aspect, the liquid is treated after it has passed through the nanobubble generator.

In another aspect, mixing the nanobubble solution with sand, gravel and cement includes mixing sand and the nanobubble solution into a slurry; adding gravel to the slurry; and adding cement to the slurry. In one aspect, more nanobubble solution can be added to the slurry. In another aspect, before mixing, a mixing vessel can be wet with the nanobubble solution.

In a second aspect of the disclosure, there is provided an apparatus for producing concrete including a mixing vessel; a nanobubble solution production apparatus for producing a nanobubble solution; and at least one apparatus for providing concrete ingredients to the mixing vessel; wherein the nanobubble solution and the concrete ingredients are mixed within the mixing vessel to produce concrete.

In another aspect, the at least one apparatus includes a cement apparatus for providing cement to the mixing vessel. In another aspect, the at least one apparatus includes a sand apparatus for providing sand to the mixing vessel. In a further aspect, the at least one apparatus includes at least one ingredient apparatus for providing the at least one ingredient to the mixing vessel. In yet a further aspect, the nanobubble solution production apparatus is a nanobubble water production apparatus. In yet another aspect, the nanobubble solution production apparatus includes a nanobubble generator.

### DESCRIPTION OF THE DRAWINGS

The following figures illustrate various aspects and preferred and alternative embodiments of the disclosure.

FIG. 1 is a schematic diagram of apparatus for producing concrete;

FIG. 2 is a perspective view of one embodiment of a nanobubble generator;

FIG. 3a is a perspective view of a part of the nanobubble generator of FIG. 2;

FIG. 3b is a longitudinal cross-sectional view of the nanobubble generator of FIG. 2;

FIG. 4 is a side view of a treatment portion of the nanobubble generator;

FIG. 5 is a perspective view of the treatment portion of FIG. 4;

FIG. 6 is a front view of a disc-like element of the nanobubble generator;

FIG. 7 is an enlarged view of a longitudinal cross-section of the nanobubble generator;

FIG. 8 is a schematic diagram of a system for generating a nanobubble solution;

FIG. 9 is a schematic diagram of another embodiment of a system for generating a nanobubble solution;

FIG. 10 is a flowchart outlining a method of producing concrete;

FIGS. 11a and 11b are charts outlining experimental data;

FIGS. 12a to 12d are photographs of nanobubble water produced concrete and regular water produced concrete;

FIGS. 13a to 13g are photographs of a comparison between concrete produced with regular water and concrete produced with nanobubble water;

FIGS. 14a to 14e are photographs showing further comparisons between a nanobubble water produced concrete and a regular water produced concrete;

FIGS. 15a to 15f are a set of photographs showing further comparisons between a nanobubble water produced concrete and a regular water produced concrete;

FIGS. 16a to 16c are photographs of a nanobubble water concrete puck;

FIG. 17 is a chart outlining temperature values from a heat transfer experiment for a concrete block made with normal water; and

FIG. 18 is a chart outlining temperature values from a heat transfer experiment for a concrete block made with nanobubble water.

### DETAILED DISCLOSURE

The disclosure is directed at a method, system and apparatus for producing concrete. The method includes using a nanobubble solution, such as nanobubble water, in the production process. In current solutions, water, such as in the form of well water, is used. Use of a nanobubble solution in the production of concrete provides various advantages as will be outlined below.

Concrete is typically produced by combining a chemically inert mineral aggregate, a binder, chemical additives and water. In the current method of the disclosure, the water is replaced by a nanobubble solution. The manufacture or production of a nanobubble solution is disclosed below along with an apparatus for manufacturing the nanobubble solution.

Advantages of the nanobubble solution produced concrete may include, but are not limited to, a reduction in honeycombing, a reduction in curing time, a shrinkage in the concrete within wood or metal forms resulting in an easier release of the concrete from these forms, an increased consistency, reduced air pockets, a possible reduction in bacteria count, protection of metal parts in the construction industry, such as a rebar encapsulated by the concrete from corrosion, a possible increase in concrete strength, a possible increase in water resistance, a reduction or elimination of the need for additives, an easier to clean and keep clean concrete product.

Use of the nanobubble solution also assists to control the moisture level within the final concrete product. In another embodiment, use of the nanobubble solution concrete removes the boundary layer between the concrete and a rebar such that the concrete adheres directly to the rebar thereby reducing the likelihood of corrosion. In one embodiment, the nanobubble solution concrete creates an aerobic condition within the finished concrete which may slow the aging process of the finished concrete.

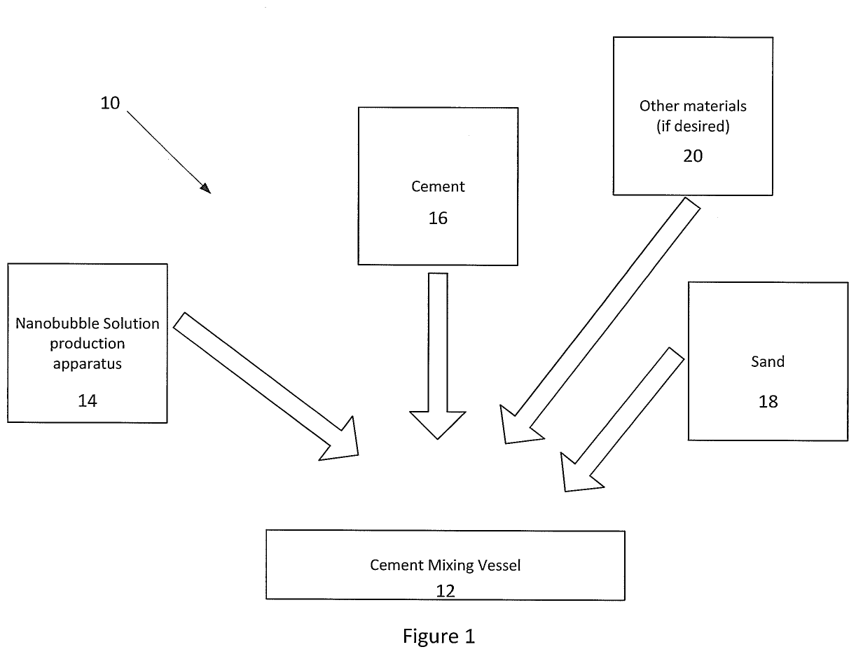

Turning to FIG. 1, a schematic diagram of apparatus for producing a nanobubble solution concrete is shown. The apparatus 10 includes a cement mixing vessel 12, such as a cement mixer, however, it will be understood that any container in which materials can be mixed is suitable. The cement mixing vessel 12 may include apparatus to mix the ingredients within the vessel as the ingredients are being added in an automated or non-automated manner. Alternatively, the ingredients may be mixed manually.

The apparatus 10 further includes a nanobubble solution production apparatus 14 that generates or produces a nanobubble solution, such as nanobubble water, to be used in the concrete production process. The apparatus 10 further includes an apparatus for adding cement 16 to the cement mixing vessel 12 along with an apparatus for adding sand 18 and one or more apparatus for adding other materials 20, if desired.

The nanobubble solution production apparatus 14 may be constructed in a variety of different embodiments to create or generate nanobubbles in a liquid or a liquid solution. The nanobubble solution production apparatus may include a nanobubble generator or any other type of nanobubble generator which is capable of providing nanobubbles in a liquid or liquid solution. In another embodiment, the apparatus 14 may include a source of liquid and a treatment module including a nanobubble generator.

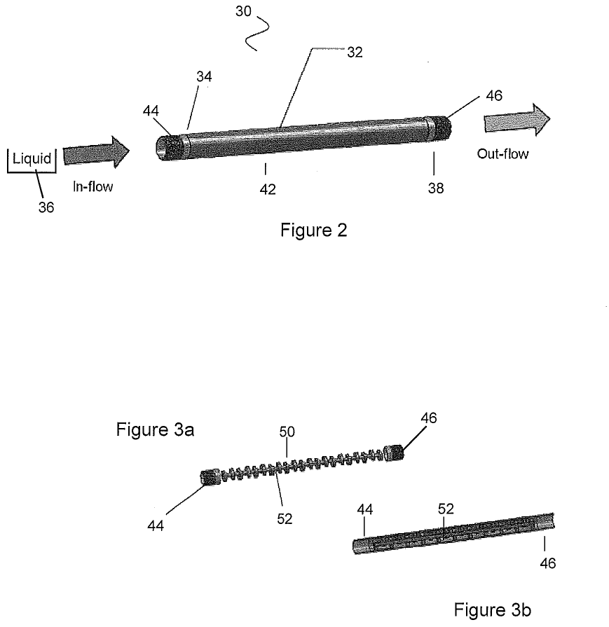

Turning to FIGS. 2 to 7, schematic diagrams of one embodiment of a nanobubble generator for use in the nanobubble solution production apparatus 14 is shown. The nanobubble generator 30 is used to assist in the generation of the nanobubble solution (nanobubble water) from a source liquid, such as, but not limited to, water.

As shown in FIG. 2, the nanobubble generator 30 may include a housing 32 having an inflow portion or end 34 for receiving a source solution or liquid (i.e. water) from a source 36, an outflow portion or end 38 for releasing the nanobubble solution 40 and a treatment portion or area 42 between the inflow end 34 and the outflow end 38 for treating the source liquid 36. The inflow end 34 and outflow end 38 may include a threaded boss 44 and 46, respectively. In a preferred embodiment, the housing 32 and bosses 44 and 46 are made of a substantially inert material, such as, but not limited to, polyvinyl chloride (PVC). In an embodiment, the housing 32 may take a substantially tubular form.

Turning to FIG. 3a, a perspective view of a treatment apparatus is shown. FIG. 3b is a section view of the nanobubble generator 30 with the treatment apparatus housed therein. The treatment apparatus 50, which can be seen as a nanobubble generating member, includes the bosses 44 and 46 at opposite ends of the treatment apparatus and a generally elongated member 52 between the two bosses 44 and 46. As can be seen in FIG. 3b, the elongated member 52 is preferably housed within the housing 32 with the bosses 44 and 46 extending out of the housing 32.

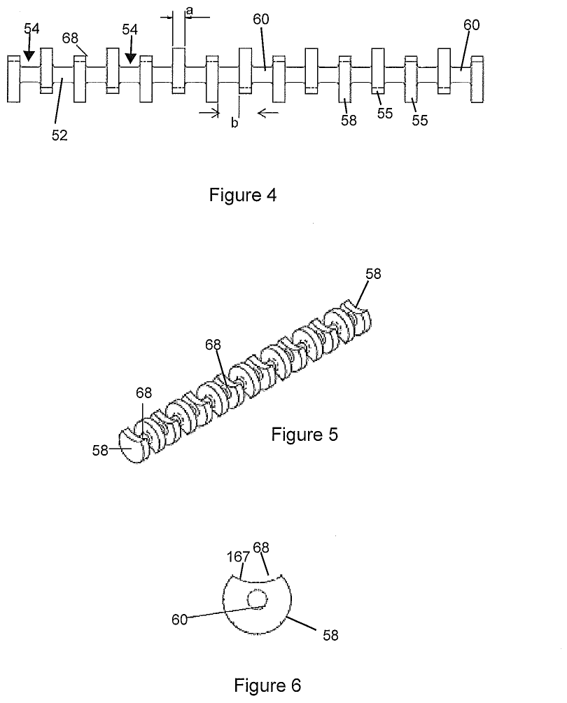

With reference to FIGS. 4 to 7, the treatment apparatus 50 of the nanobubble generator 10 may include a series of sequential cavitation zones 54 and shear surface planes 56. The series of sequential cavitation zones 54 and shear surface planes 56 may be enabled by having the generally elongated member 52 having a series of two or more spaced apart elements 58 which extend axially through the housing 32 and may be interposed between the inflow 34 and outflow 38 ends, or portions of the nanobubble generator 30. In one embodiment, between two (2) and thirty (30) spaced apart elements 58 may be used while in another embodiment, more than thirty (30) spaced apart elements 58 may be used. It will be understood that any number of spaced apart elements 58 may be used.

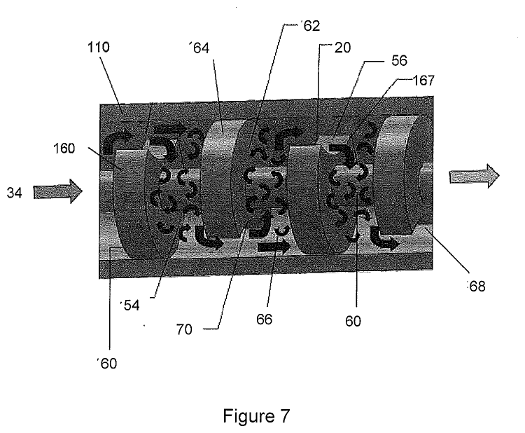

The elements 58, which in a preferred embodiment, are disc-shaped, may be supported upon or mounted on a central rod or shaft 60 of the elongated member 52. With reference to FIG. 7, each element 58 may include opposite walls 60 and 62 (also referred to as shear walls) and a peripheral or side wall 64. One shear wall 60 may face the inflow end 34 and the opposite shear wall 62 may face the outflow end 38 of the nanobubble generator 30. The peripheral wall 64 may extend between opposite shear walls 60 and 62. The disc-like elements 58 may be held in spaced relation to each other and may be separated from one another by a space 66.

Furthermore, each element 58 is preferably formed with at least one groove or notch 68 extending from its peripheral wall 64. In a preferred embodiment, the notch extends in a downward direction. Each groove or notch 68 may include edges or shear edges 70 and a shear surface plane 56 between the shear edges 70. The shear surface plane 56 may be viewed as a continuation of the peripheral wall 64 into the groove or grooves 68. The edges 70, which may have a scallop design, may be substantially sharp as to be able to shear the liquid passing through the nanobubble generating apparatus 10.

In one embodiment, the disc-like elements 58 may be laser cut and may be manufactured from a single metal. Preferably the disc-like elements may be made of a corrosion resistant metal. More preferably, the disc-like elements 58 may be made from stainless steel 300 series, such as 316L.

As illustrated in FIG. 4, in a preferred embodiment, a width of each disc-like element 58 can be seen as “a” and therefore a width of the shear plane surface is preferably about one half the distance “b” or space 66 between two consecutive disc-like elements 58.

As further illustrated in FIGS. 4 to 7, the axially successive discs 58 are arranged along the rod 60 with their notches or grooves circumferentially staggered in relation to one another. The elements 58 may be arranged on the rod 60 such that the notches 68 of adjacent elements 58 are in an alternating pattern. That is, if a notch in one disc-like element 58 is facing down, the notch in the following, or adjacent, disc-like element is facing up.

As shown in FIG. 7, each disc-like element 58 may be disposed substantially perpendicular to the flow of the liquid solution within the housing 32, such that the elements 58 may substantially block any direct fluid flow through the housing 32 and as a result the fluid flow is directed to pass through, over, or by, the notches, grooves or apertures 68 of the elements 58. Due to the alternating arrangement of the grooves 68, the fluid flow between the elements 58 is turbulent and by virtue of the differing cross-sectional areas of the grooves 68 in each element 58, the width of the elements, and the space 66 between the elements 58, the liquid is caused to accelerate and decelerate on its passage through the housing 32 to ensure a turbulent flow over the surfaces of the elements 58. The nanobubble generator may be unidirectional and unipositional as shown by the arrows in FIGS. 2 and 7.

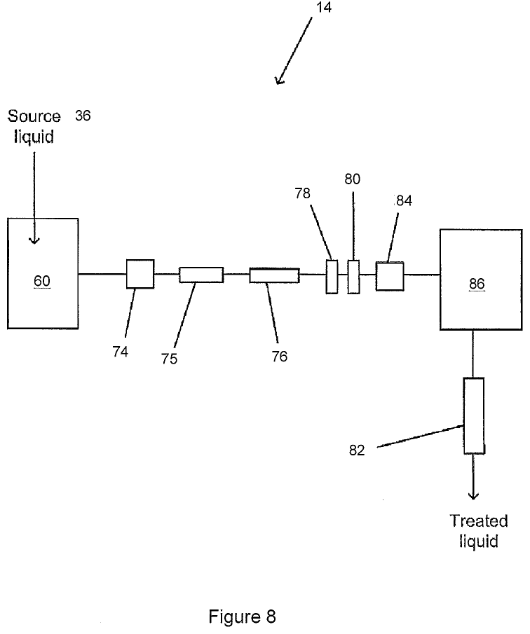

FIG. 8 shows a first embodiment of a nanobubble solution production apparatus 14 for producing nanobubbles in a liquid. The liquid is preferably provided by the liquid source 36. In one embodiment, the apparatus 14 may include an optional source liquid pre-treatment system 74, a first nanobubble generator 75, an optional high zeta potential crystal generator 76, an optional pre-filtration system 78, an optional at least one filtration device 80, and an optional second nanobubble generator 82. The apparatus 14 may also include a pump 84 and a storage container 86. The pre-treatment system 74, the first nanobubble generator 75, the zeta potential shift crystal generator 76, the pre-filtration system 78, the filtration device 80 and the second nanobubble generator 82 are preferably in liquid communication with one another and are connected by way of a conduit system. The conduit system may include, for example, pipes, hoses, tubes, channels, and the like.

The liquid for the source liquid 36, such as water, well water or tap water, is supplied from any suitable source (for example a faucet) and the liquid may be stored in a reservoir 88. Examples of the source reservoir 88 may include, but are not limited to, water heaters, cooling towers, drinking water tanks, industrial water supply reservoirs, and the like. Source liquid may be added continuously or intermittently to liquid reservoir 88. Alternatively, the liquid may be supplied continuously or intermittently from any source. The composition of source liquid may be tested and, if necessary, additional minerals and other constituents may be added to provide a sufficient source for generation of nanobubbles. The source liquid may also be treated, prior or subsequent being held in the reservoir 88 by pre-treatment system 74 to substantially remove unwanted contaminants that may interfere with the treatment process, such as, but not limited to, debris, oil-containing constituents, and the like.

In operation, the liquid solution preferably flows through either or both of the first and second nanobubble generators 75 and 82 with enough force and pressure to initiate an endothermic reaction to create the nanobubbles with paramagnetic attributes. The pump 84 may be used to generate this force and pressure. Although not shown, other pumps may be located within the apparatus 14 to assist in generating adequate pressure for passing the source liquid through either nanobubble generator. As such, the liquid solution may be actively pumped towards either nanobubble generator. The treated liquid 40 can then be released using a passive system, such as located in a plume to treat the water before a water turbine or propeller.

As shown in FIG. 8, before reaching the at least one filtration device 80, the treated liquid may optionally be passed through a zeta potential crystal generator 76. High zeta potential crystal generators are known in the art and generally useful for the prevention or reduction of scaling. The high zeta potential crystal generator 76 may increase zeta potential of crystals by electronically dispersing bacteria and mineral colloids in liquid systems, reducing or eliminating the threat of bio-fouling and scale and significantly reducing use of chemical additives.

As further shown in FIG. 8, after passage through the first nanobubble generator 75 and the optional high zeta potential crystal generator 76, and before reaching the optional filtration device 80, the liquid may optionally be passed through the pre-filtration system 78, wherein minerals, such as iron, sulphur, manganese, and the like are substantially removed from the treated source liquid. Pre-filtration system 78 can be, for example, a stainless steel mesh filter. If necessary, or desired, the liquid output of the first nanobubble generator 75 may be passed through the at least one filtration device 80. In a preferred embodiment, filtration device 80 reduces, substantially reduces or eliminates bacteria, viruses, cysts, and the like from the treated liquid. Any filtration devices known in the art may be used. Filtration device 80 may include, but is not limited to, particle filters, charcoal filters, reverse osmosis filters, active carbon filters, ceramic carbon filters, distiller filters, ionized filters, ion exchange filters, ultraviolet filters, back flush filters, magnetic filters, energetic filters, vortex filters, chemical oxidation filters, chemical addictive filters, Pi water filters, resin filters, membrane disc filters, microfiltration membrane filters, cellulose nitrate membrane filters, screen filters, sieve filters, or microporous filters, and combinations thereof. The treated and filtered liquid may be stored or distributed for use and consumption.

The pump 84 is provided downstream from the first nanobubble generator 75 and treated liquid 40 is released and distributed intermittently or continuously for various liquid system applications. As discussed above, the pump, or another pump, may be provided upstream from the first nanobubble generator 75.

The treated liquid, now having a high concentration of nanobubbles, may be distributed to and stored in a storage container 86, such as a reservoir or directly delivered to apparatus for concrete production such as the cement mixing vessel 12 of FIG. 1. In this embodiment, before distribution of the stored treated liquid, the stored liquid may be passed through the second nanobubble generator 82, for generation of additional nanobubbles in the treated source liquid. The twice treated liquid may then be distributed for use in the concrete production process. It should be understood that the system may include more than two nanobubble generators to further increase the number of nanobubbles within the liquid solution.

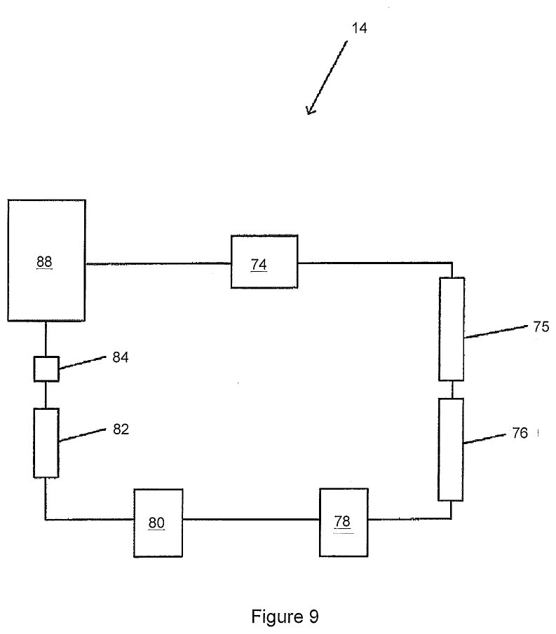

FIG. 9 illustrates another embodiment of a nanobubble solution production apparatus 14. The apparatus 14 is similar to the one shown in FIG. 8 and includes the reservoir 88 that store the source liquid 36, an optional source liquid pre-treatment system 74, a first nanobubble generator 75, an optional high zeta potential crystal generator 76, an optional pre-filtration system 78, at least one optional filtration device 80 and an optional second nanobubble generator 82. The pre-treatment system 74, nanobubble generator 75, high zeta potential crystal generator 76, pre-filtration system 78, filtration device 80, and second nanobubble generator 82 are in liquid communication with one another and are connected by way of a circulating conduit system.

In the embodiment shown in FIG. 9, the conduit system connecting the components can be seen as being in a loop-like manner. Exemplary conduit systems may include, but are not limited to, pipes, hoses, tubes, channels, and the like, and may be exposed to the atmosphere or enclosed. The embodiment of FIG. 9 provides continuous or intermittent circulation of the source liquid through the components of the apparatus 14.

Continuous or intermittent treatment of the source liquid by the nanobubble generator system eventually arrives at a point in time where the entire volume of the source liquid within the apparatus 14 is treated by at least one of nanobubble generator 75 or nanobubble generator 82. In other words, the liquid within the apparatus 14 may eventually arrive at an equilibrium-like state, where the entire volume of the liquid within the apparatus 14 has been treated to generate nanobubbles.

While microbubbles tend to coalesce to form large buoyant bubbles which either float away or collapse under intense surface tension-derived pressure to the point that they vanish, the nanobubbles generated by either nanobubble generator 75 or 82 generally remain in suspension as the gases within them do not diffuse out.

Before passing through the optional filtration device 80, the treated liquid from the first nanobubble generator 75, containing a high concentration of nanobubbles, may optionally be passed through high zeta potential crystal generator 76 for generating high zeta potential crystals within the liquid to substantially remove minerals that can cause the formation of scale.

After passage through the high zeta potential crystal generator 76, the liquid may optionally be passed through pre-filtration system 78, wherein minerals, such as iron, sulphur, manganese, and the like are substantially removed from the treated source liquid before being passed through the filtration device 80.

The output from the filtration device 80 may then be passed through the optional second nanobubble generator 82 for generating additional nanobubbles. The continuous and intermittent treatment of the source liquid by one of the nanobubble generators 75 or 82 eventually results in the entire volume of the source liquid within the apparatus 14 being treated by one of the nanobubble generators 75 or 82.

The nanobubble solution produced with the methods and systems disclosed above may include a substantially high concentration of stable nanobubbles, or an enhanced concentration of stable nanobubbles.

In one embodiment of nanobubble solution production, a source liquid may be passed, at a suitable pressure, through the nanobubble generator which may initiate an endothermic reaction. For instance, a suitable pressure for the systems shown in FIGS. 8 and 9 may be between 2 and 8 bar and more preferably about 3.2 bar. The endothermic reaction, in which the water cools down from between 2 to 4 degrees Celsius upon first treatment, is indicative of an energy conversion within the water itself.

If the elements 58 are manufactured from a single metal, such as a corrosion resistant metal (such as for example stainless steel 300 series), the ions it produces, through the shearing action on water as it passes over the elements 58, then act as catalysts in creating the endothermic reaction.

The reaction may be initiated by the energy of the water flow at a predetermined pressure over the series of elements 58 within the generator 32. In one embodiment, there may be a total of 21 elements in a small nanobubble generator and 25 elements in a larger nanobubble generator. Each element within the generator may act as a shear plane and may be positioned substantially perpendicular to the liquid solution flow in order that the entire surface of the shear plane is utilized. The spacing between the elements in the generator may also be adjusted to ensure that there is a suitable degree of cavitation. In one embodiment, the space between two adjacent discs is about 2 times the width of the discs.

With reference to FIG. 7, as liquid (represented by the broad arrows in FIG. 7) enters into the cavitation zone or chamber, a number of reactions may be taking place substantially simultaneously, including: cavitation, electrolysis, nanobubble formation, and a re-organization of the water liquid structure. As the liquid solution flows through the nanobubble generator, the simultaneous reactions referred to before, may be replicated sequentially according to the formula n−1 times, wherein “n” is the number of disc-like elements 58 to increase the kinetic energy frequency of the solution.

The resultant nanobubble containing liquid solution has increased paramagnetic qualities that may influence everything the water is subsequently used for, or used in. The nanobubbles produced after passage of source liquid solution through the nanobubble generator are of a different size and properties than the small-sized bubbles present in untreated liquid sources or in current treated liquids.

In one embodiment, the nanobubbles may be sized between about 10 and about 2000 nanometers and any range there in between. For example, the nanobubbles of the nanobubble water may be sized between about 10-1000 nm; between about 10-900 nm; between about 10-850 nm; between about 10-800 nm; between about 10-750 nm; between about 10-700 nm; between about 10-650 nm; between about 10-600 nm; between about 10-550 nm; between about 10-500 nm; between about 10-450 nm; between about 10-400 nm; between about 10-350 nm; between about 10-300 nm; between about 10-250 nm; between about 10-200 nm; between about 10-150 nm; between about 10-100 nm; between about 10-90 nm between about 10-80 nm; between about 10-70 nm; between about 10-60 nm; between about 10-50 nm; between about 10-40 nm; between about 10-30 nm; and between about 10-20 nm.

In one embodiment, the nanobubbles of the nanobubble water may have a mean size of under about 100 nm. In another embodiment, the nanobubbles may have a mean size of under about 75 nm. In one embodiment, the nanobubbles of the nanobubble water may have a mean size of under about 60 nm. In another embodiment, the nanobubbles may have a mean size of under about 50 nm.

Treated liquid, after passage through nanobubble generator, contains a high concentration of nanobubbles. In one embodiment, the nanobubble concentration in liquid material following treatment in the nanobubble generator system may be between about 1.13 and 5.14 E8 particles/ml. In another embodiment, the concentration of nanoparticles may be between about 3.62 and 5.1 E8 particles/ml.

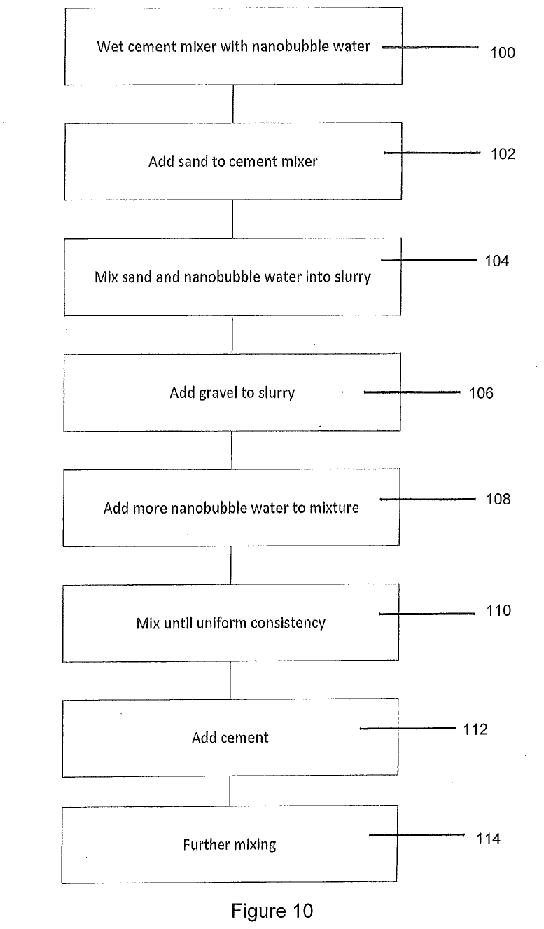

Turning to FIG. 10, a flowchart outlining a first method of producing concrete is shown. Initially, a cement mixer or cement mixing vessel is wet with a nanobubble solution, such as nanobubble water, 100. The nanobubble water may be produced using a nanobubble solution production apparatus 14, such as the one disclosed above or may be produced using other known nanobubble solution production apparatus

Sand is then inserted into the cement mixing vessel to mix with the nanobubble water 102. The sand and the nanobubble water are mixed to produce a slurry 104. Gravel can then be added to the slurry 106 along with more nanobubble water 108. These ingredients are then mixed 110 until there is a uniform consistency. Cement is then poured into the cement mixing vessel 112 and further mixing is performed 114 until it is ready for pouring or use. The characteristics or consistency of the concrete is defined by the individual mixing the ingredients or the desired concrete characteristics. Furthermore, the placement, conditioning and curing of the mixture (or cement) will be understood by those skilled in the art.

In one experiment, concrete was produced using both nanobubble water and well water. Initially, a form, or mold, was constructed using ½ inch plywood with 2×6 ends and a separation divider in the middle. The form was then divided into two separate sections for receiving the two different types of concrete. The dimensions of the entire mold was 8 feet with each half section being 2 ft high×4 ft wide×6 inches deep. A 3¼ inch rebar was also placed into each half section. In this experiment, the concrete was produced using the ingredients and ratio of 1 part cement, 2 parts sand, 3 parts gravel and 5 gallons of nanobubble water or water.

Initially, it was noted that the consistency of the nanobubble water cement mixture binded together such that greater amounts of the mixture could be moved at one time. Also, the cement mixture with the nanobubble water had a higher level of stiffness (compared to the cement mixture with the regular water) as it was binding together. As such, a higher loading capacity for the nanobubble water cement mixture was observed. Use of the nanobubble water also caused the sand to cake up more uniformly than the sand in the regular water concrete mixture. Also, the sand did not bind to the interior of the cement mixing vessel with the nanobubble water.

During the curing time, water within the nanobubble water cement mixture came to the surface within about 30 minutes. The heat differential was also seen as being greater with the nanobubble water cement mixture. Also, when the mold was removed from the cement, the removal of the mold away from the nanobubble water cement mixture was performed with little force. The nanobubble water cement mixture also showed a 50% reduction in honeycombing and pinholing compared with the regular water cement mixture.

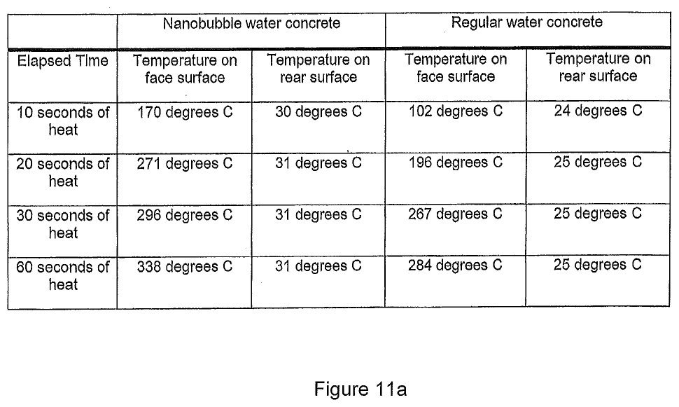

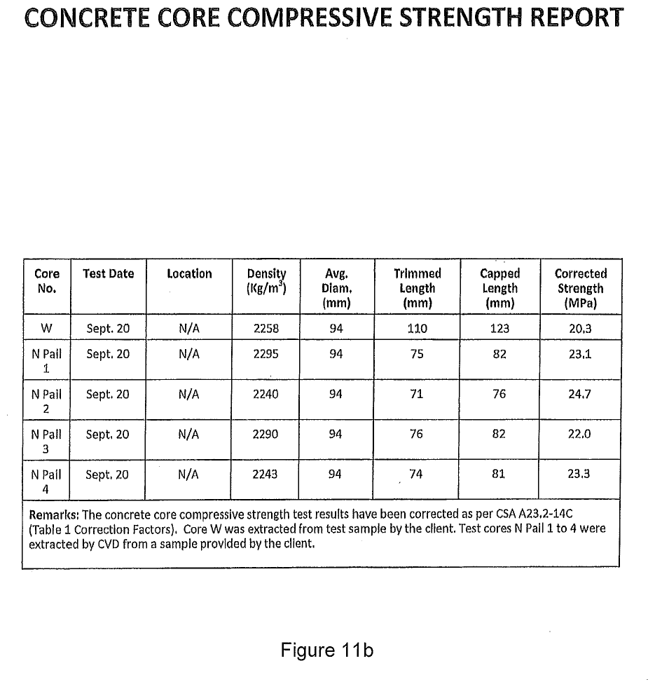

As outlined in FIGS. 11a and 11b, various benefits were achieved and recognized during testing and experiments when using nanobubble water instead of regular water in the production of concrete.

In one set of testing (FIG. 11a), a series of heat tests were performed on a concrete produced with nanobubble water and a concrete produced with regular water. The heat tests were carried out at the same intervals and times using a propane gun set at a heat of 100 BTUs. As can be seen, the concrete produced with nanobubble water heated up more quickly on its surface and retained heat at the surface. As such, it may be seen that the concrete produced using nanobubble water is denser and has a higher heat retention than concrete made with regular water using the same ingredients and ratio of ingredients.

In FIG. 11b, a compressive strength report is shown for samples of a nanobubble water produced concrete.

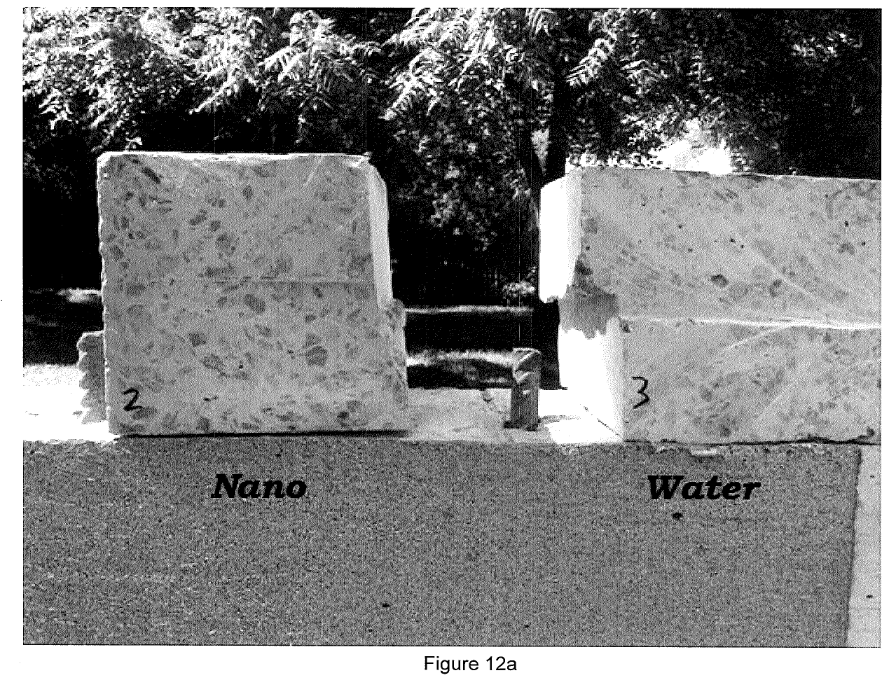

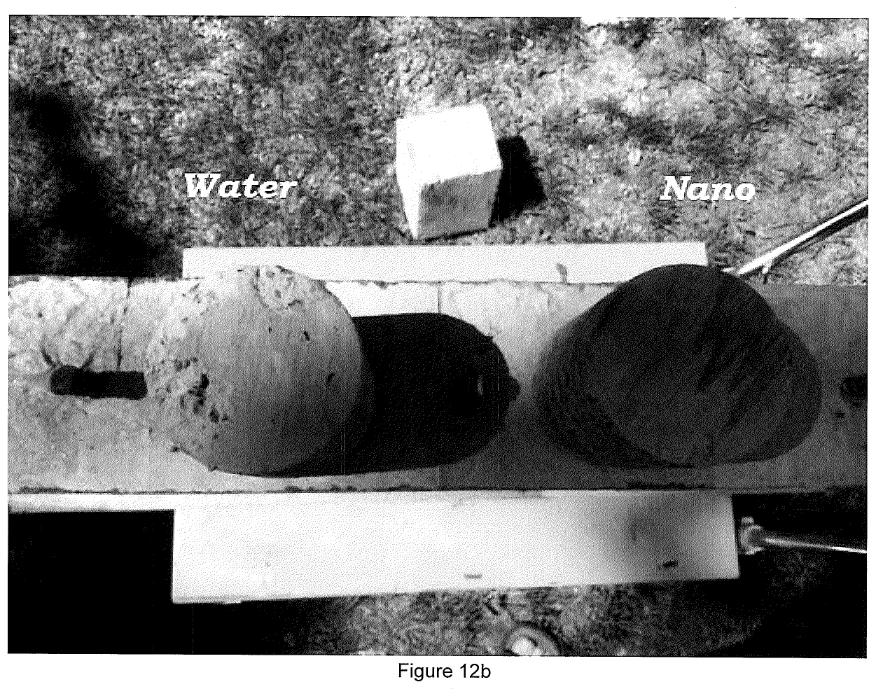

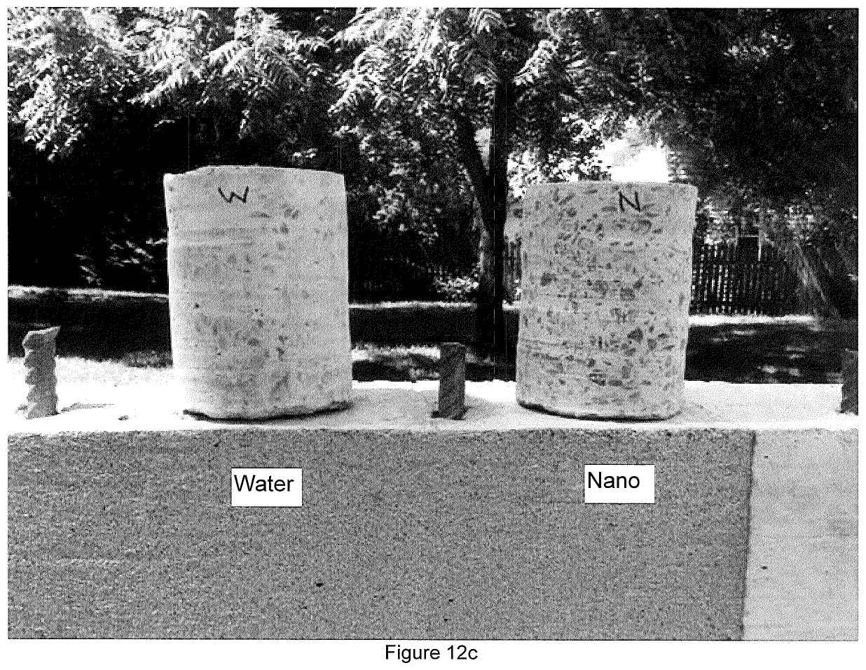

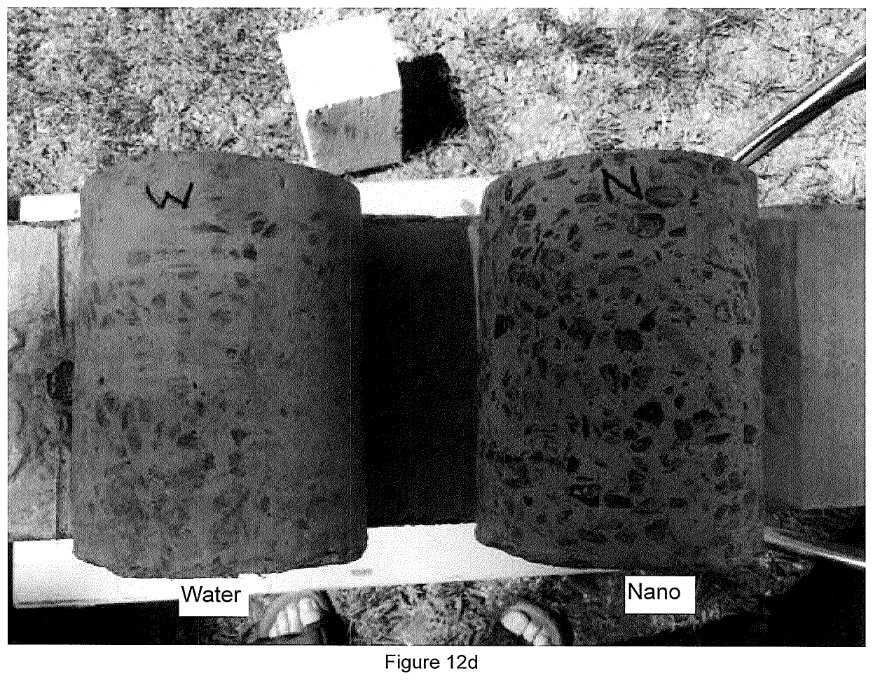

Turning to FIGS. 12a to 12d, photographs showing examples of nanobubble water produced concrete and regular water produced concrete are provided. The photographs reflect core and cut samples of the two concretes.

As shown in FIGS. 12a to 12d, the nanobubble water produced concrete is labelled “Nano” while the regular water produced concrete is labelled “Water”. The time to cut shapes out of the concrete blocks of FIG. 12a was about three (3) minutes for the nanobubble water produced concrete and about six (6) minutes for the regular water produced concrete. Various views of the resulting shapes are shown in FIGS. 12b to 12d. Although not shown, in one experiment, a thermoplastic was placed over each concrete sample whereby it was noticed that less heat was required to adhere the thermoplastic to the nanobubble water produced concrete.

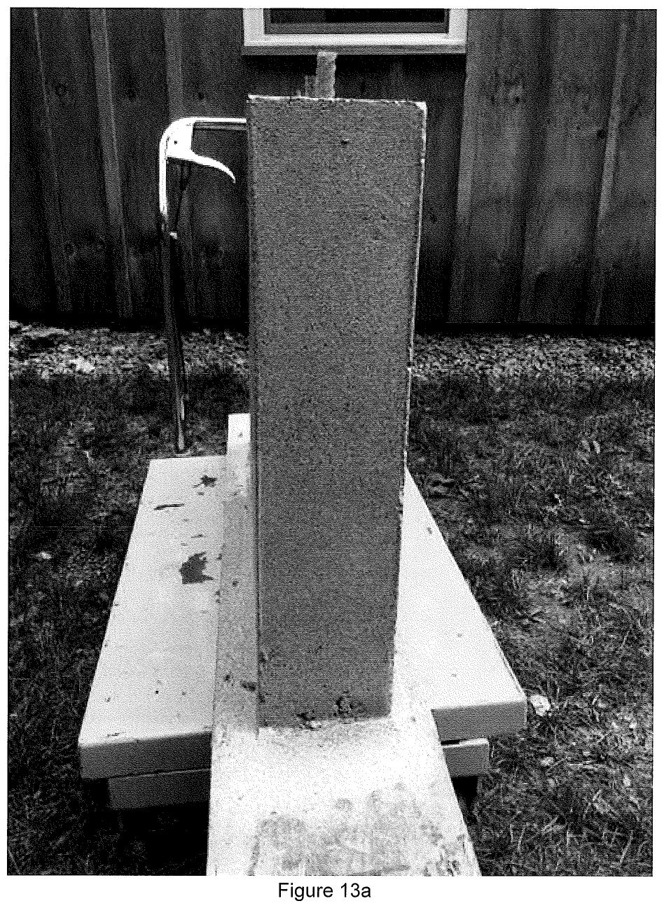

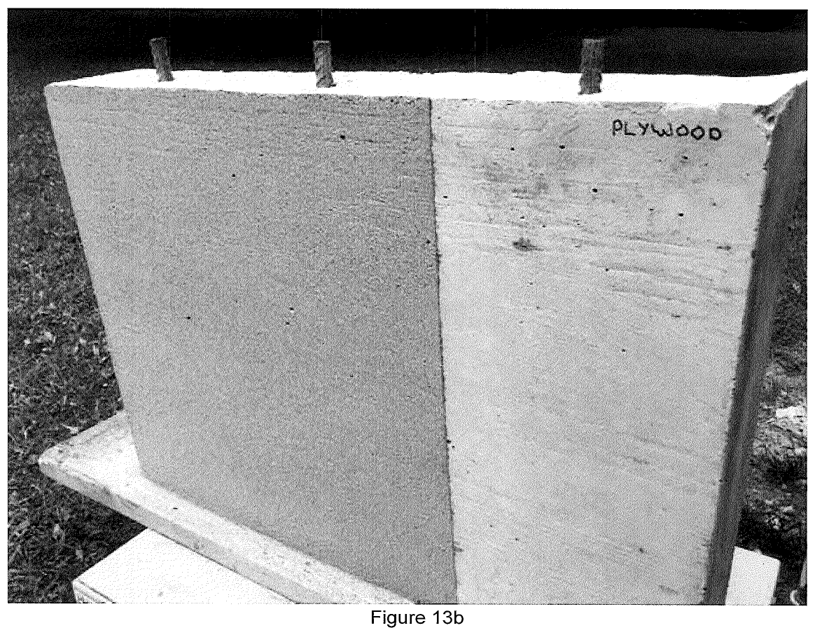

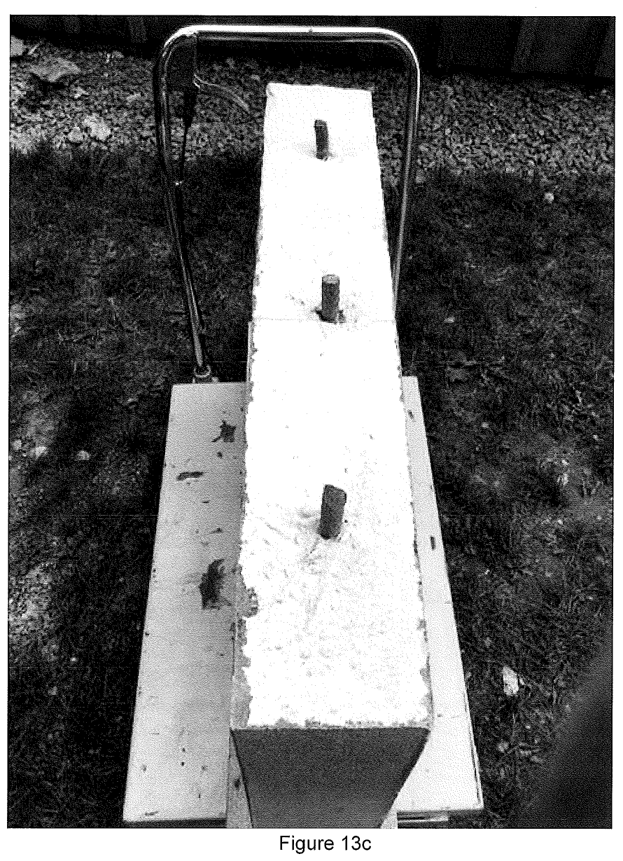

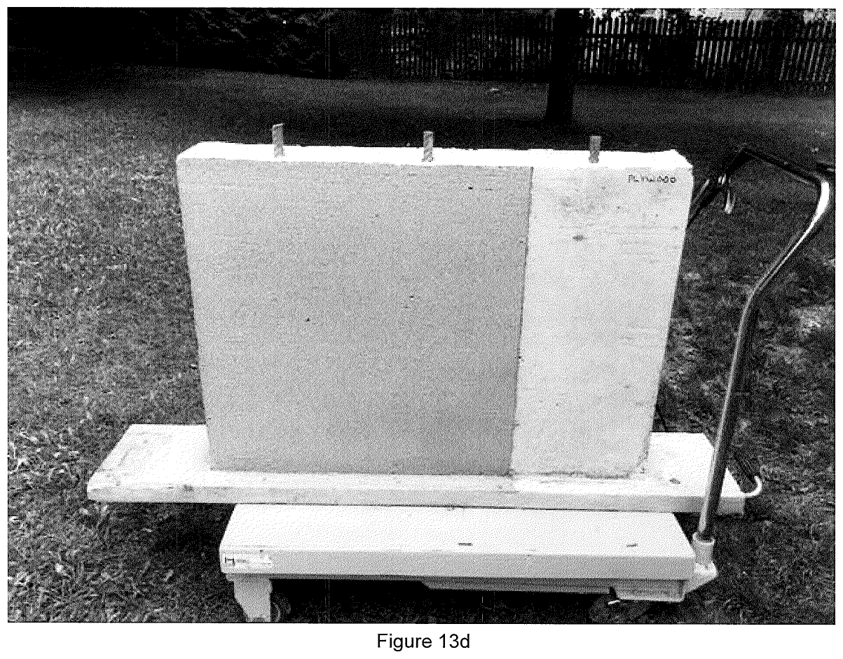

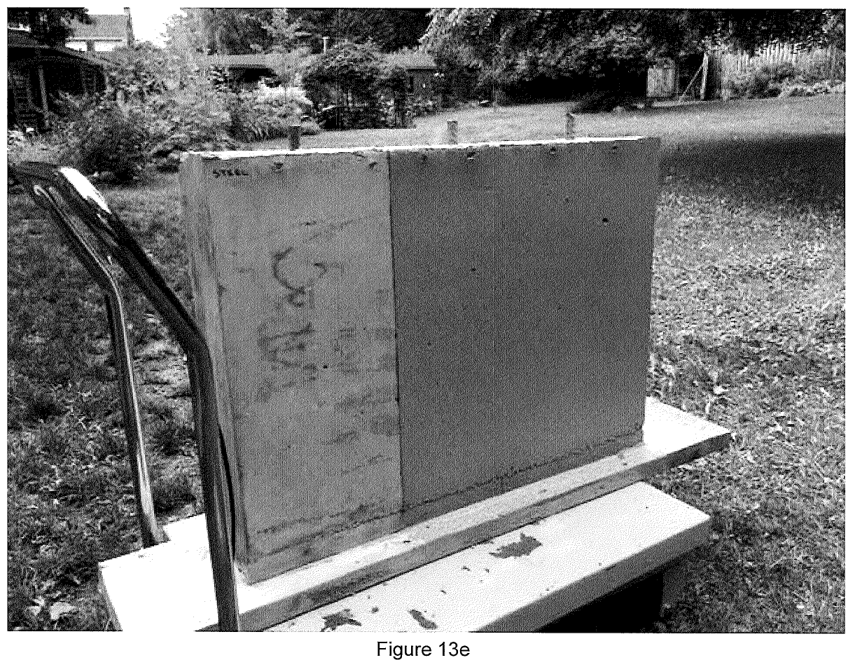

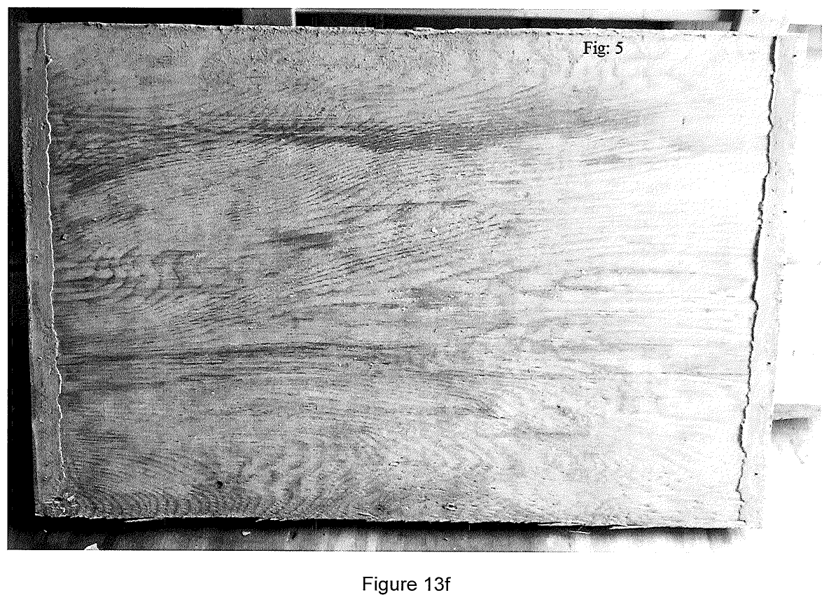

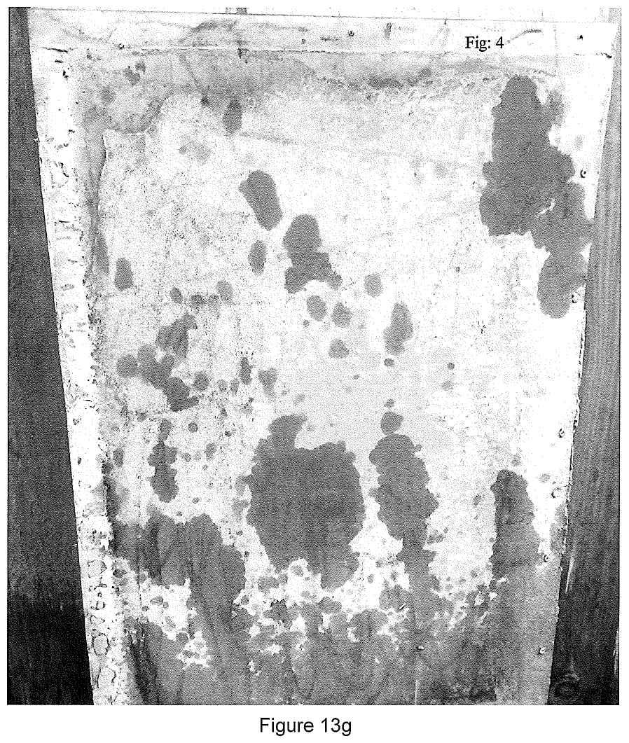

FIGS. 13a to 13e are photographs showing a nanobubble water concrete block after a thermoplastic has been applied to its surface. It was seen that the finish on the concrete block was very smooth. A piece of plywood (as can be seen for example in FIG. 13b) was used as a form or mold on one side of the concrete block while a piece of steel was used on the opposite side. FIG. 13f is a photograph of the plywood after it was removed. FIG. 13g shows the piece of steel after it was removed from the concrete. As can be seen, there is little residue left on either of the surfaces, which reflects an advantage of the nanobubble water produced concrete over regular water produced concrete.

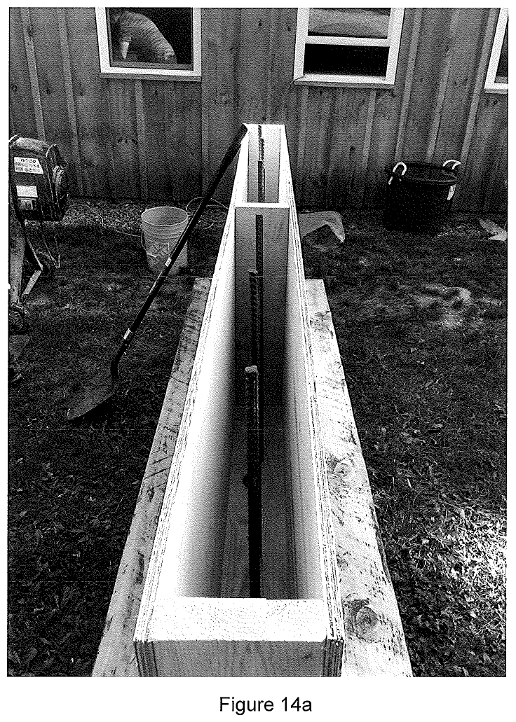

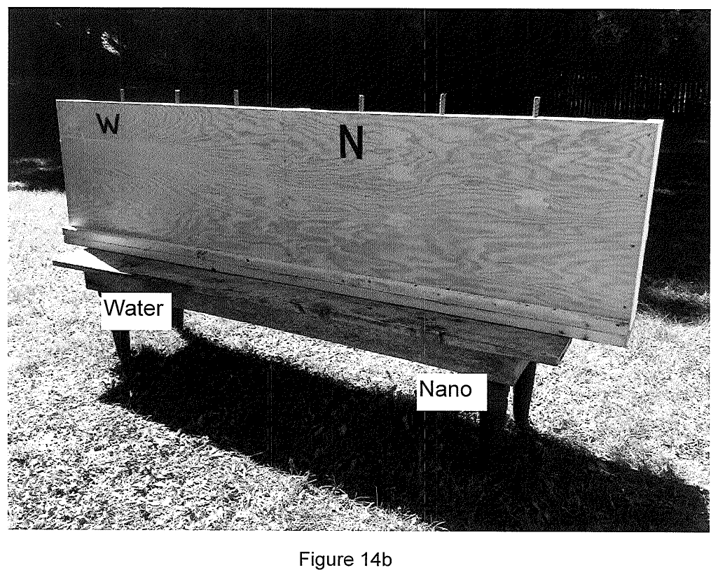

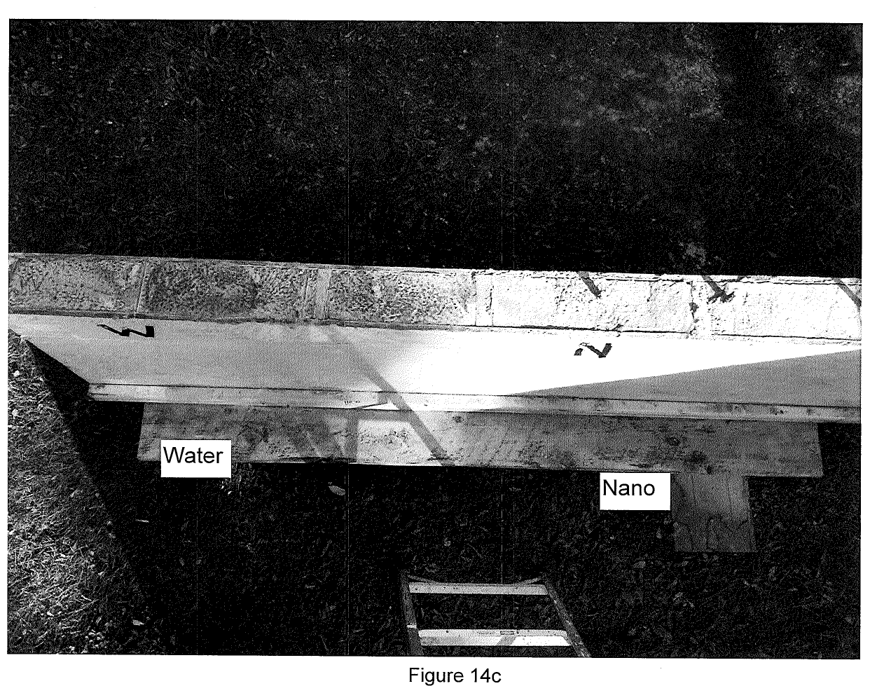

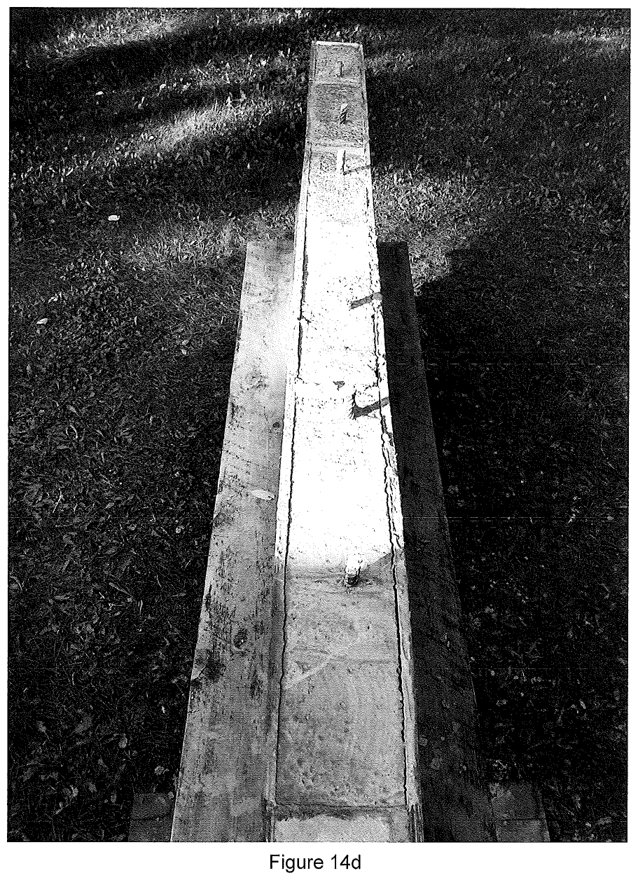

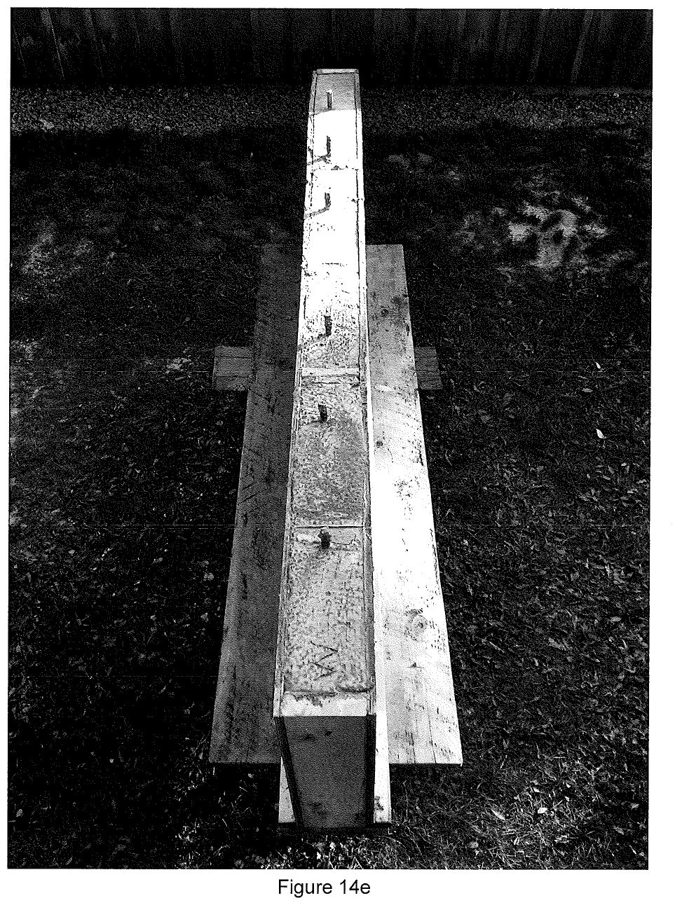

Turning to FIGS. 14a and 14b, two photographs are provided which show a form or mold that was used in testing characteristics of a nanobubble solution, or nanobubble water, produced concrete and a regular water produced concrete. The form includes two sections, separated by a middle wall. The sides in which the concrete mixtures were poured are marked “W” for regular water produced concrete and “N” for nanobubble water produced concrete. A set of spaced apart rebars were also placed within the mold.

After the two molds were filled with the different concrete mixtures in each section and allowed to cure, the mold was removed. In the experiment, the “W′ concrete was produced with 1 part Portland limestone cement, 2 parts construction sand and 2.5 parts construction stone with 4 cubic feet of” regular water. The “N” concrete was produced with 1 part Portland limestone cement, 2 parts construction sand and 2.5 parts construction stone with 4 cubic feet of nanobubble water. FIGS. 14c to 14e are photographs showing the mold after it has been filled with the “W” concrete mixture and the “N” concrete mixture.

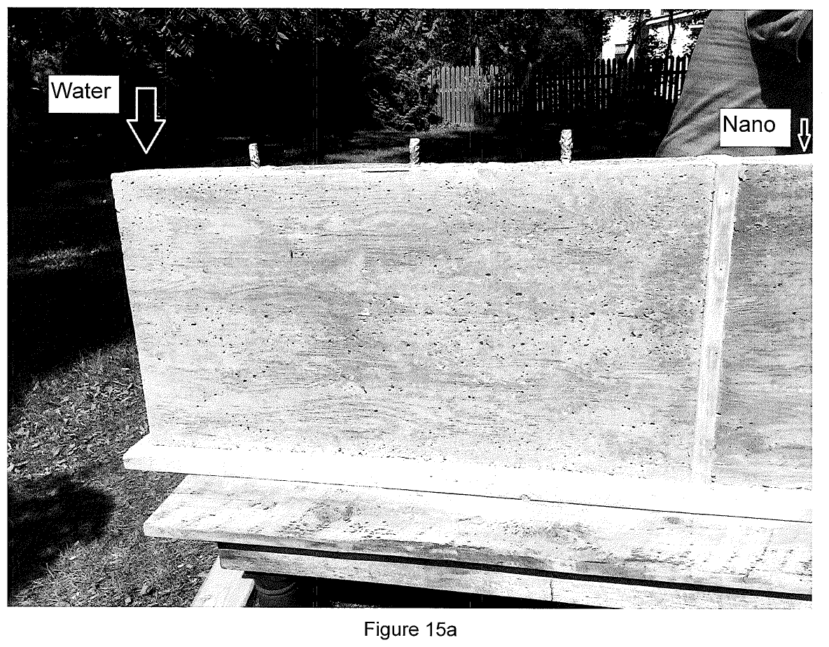

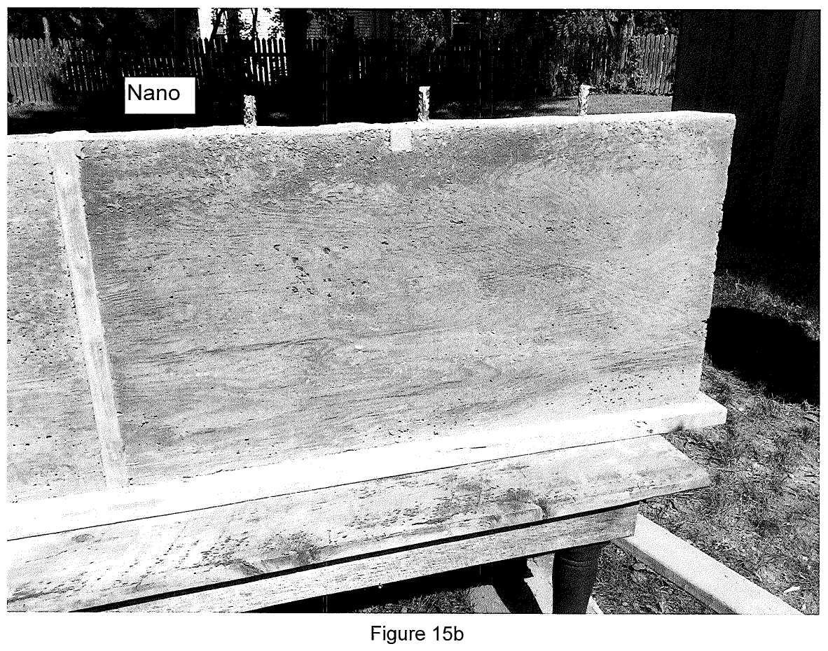

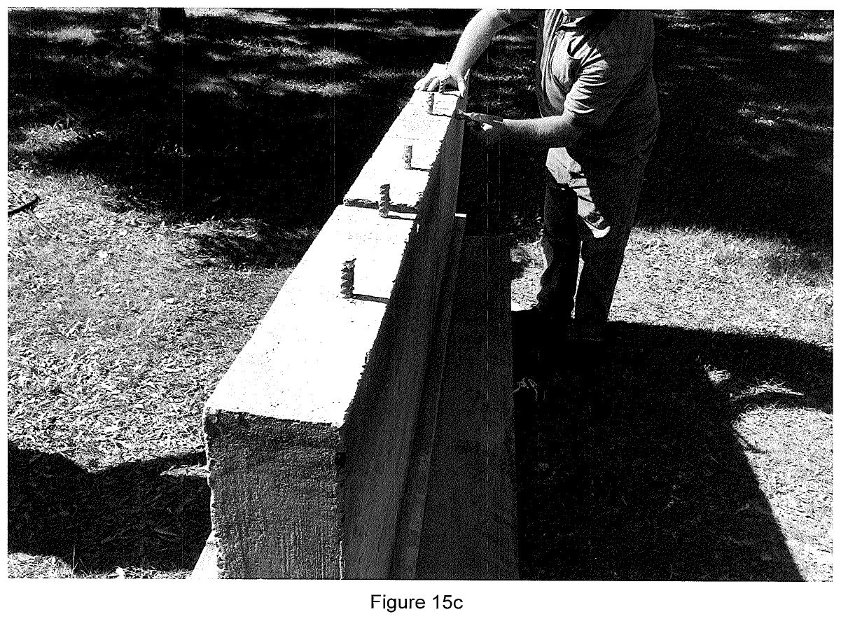

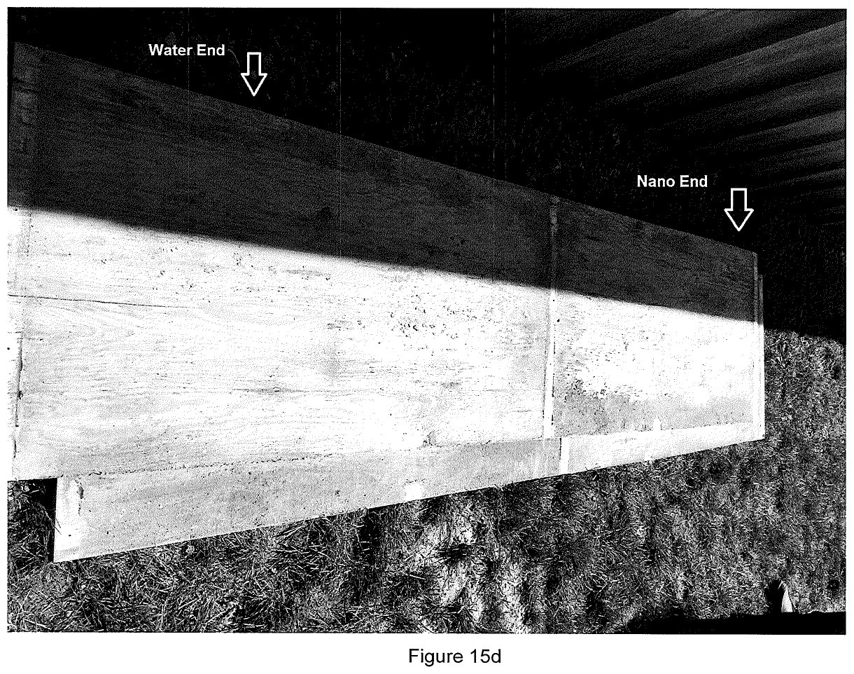

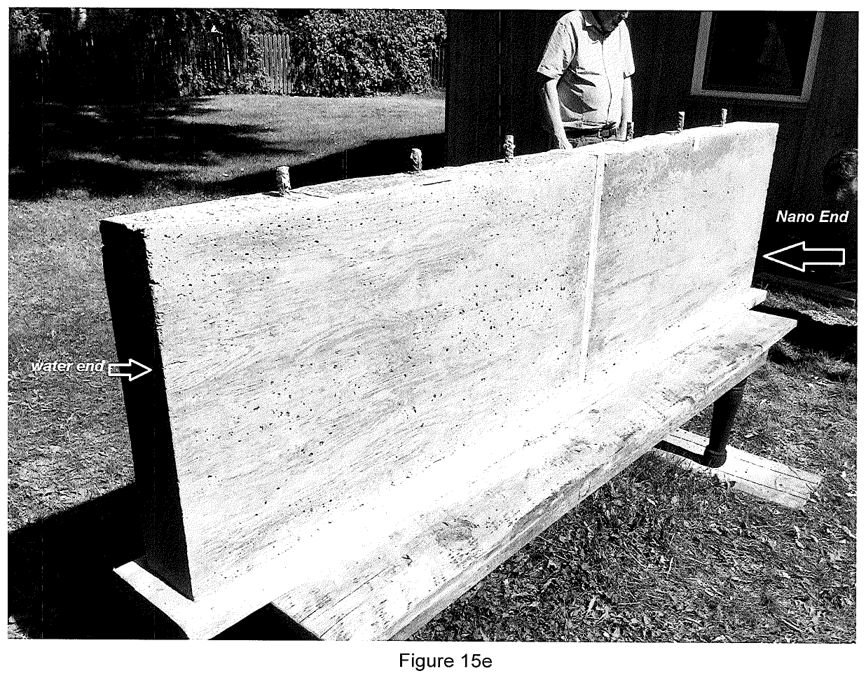

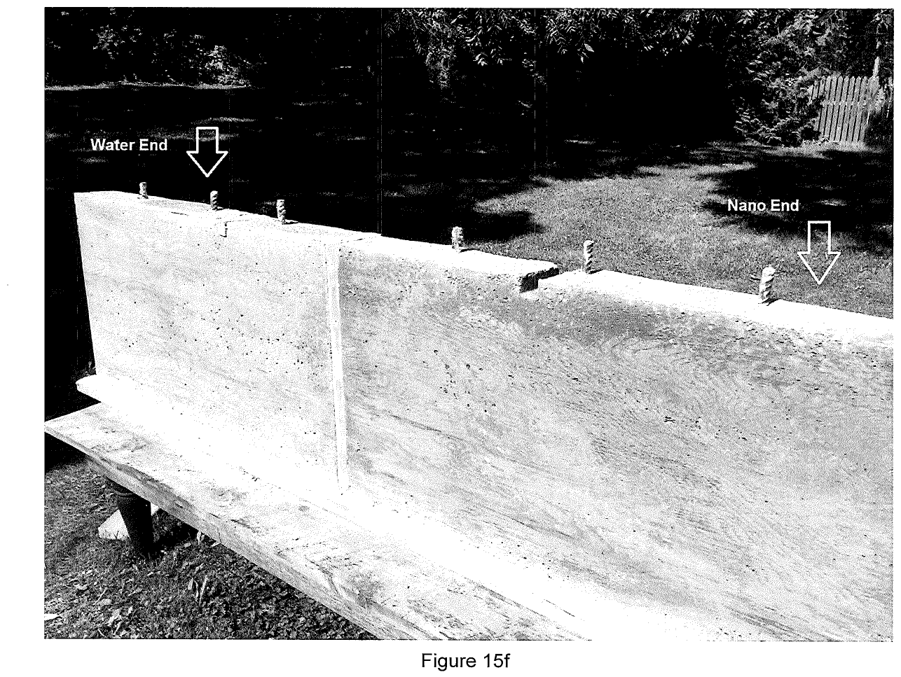

FIG. 15a is a photograph of the regular water “W” end of the concrete block after the mold was removed and FIG. 15b is a photograph of the nanobubble water “N” end of the concrete block after the mold was removed. FIG. 15c is a photograph of an individual removing a wood insert from the “N” end of the block. It was observed that it was easier to remove the mold from the “N” end compared with the “W” end. FIG. 15d is a photograph of a portion of the mold which was in contact with the two concrete blocks.

FIGS. 15e and 15f are further views of the concrete block after the mold was removed. As can be seen in FIG. 15f, the wooden insert that was formed within the “N” end of the concrete block has been removed. It was seen that the wooden insert was more easily removed from the nanobubble water concrete block than it was from the regular water concrete block.

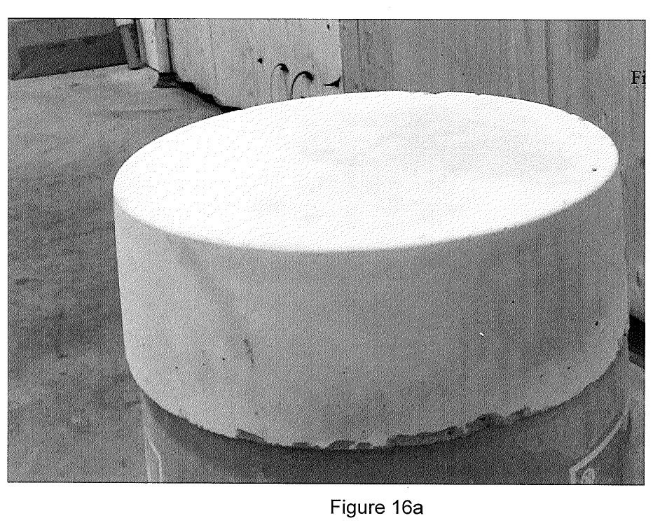

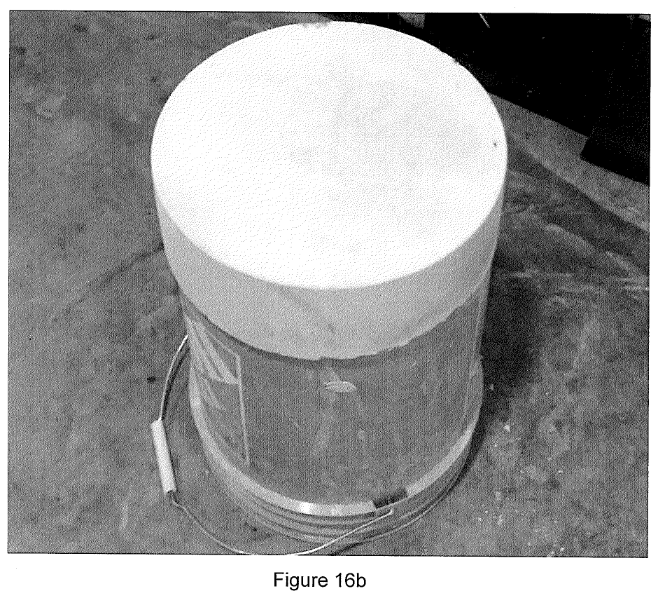

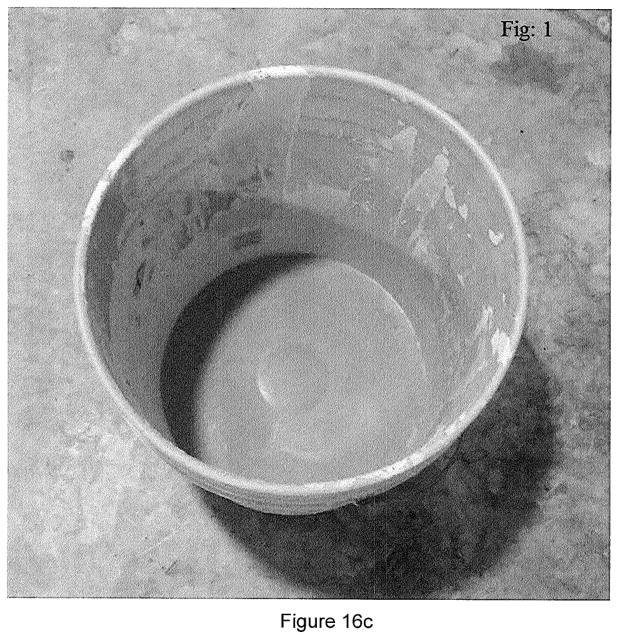

FIGS. 16a to 16d are photographs of a puck made of nanobubble water produced concrete. FIG. 16a is one perspective view of the nanobubble water puck while FIG. 16b is a second perspective view of the puck on top a pail from which it was formed. FIG. 16c shows the inside of the pail after the puck is removed. As can be seen, there is little residue left over after the puck has been removed which is an advantage of the nanobubble water produced concrete of the disclosure.

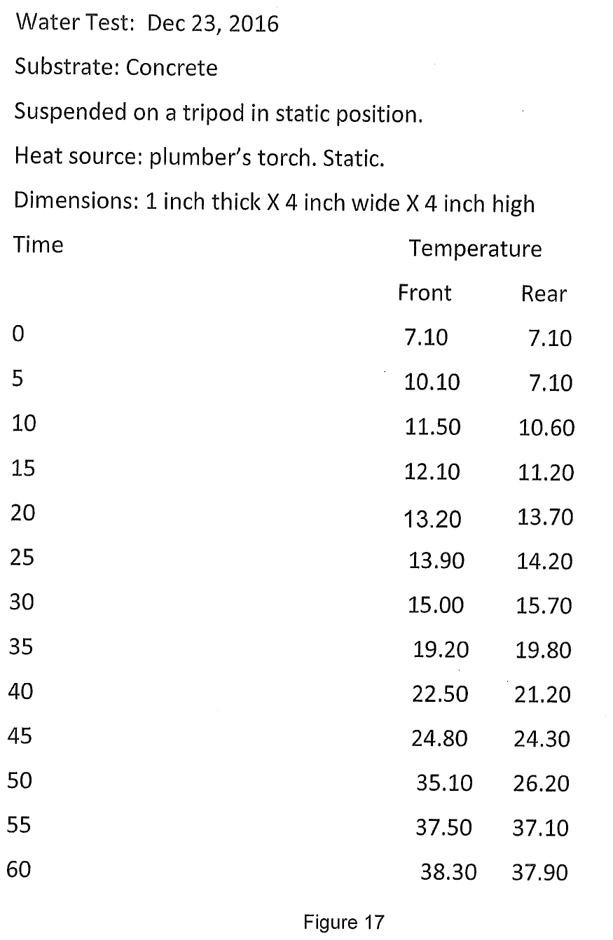

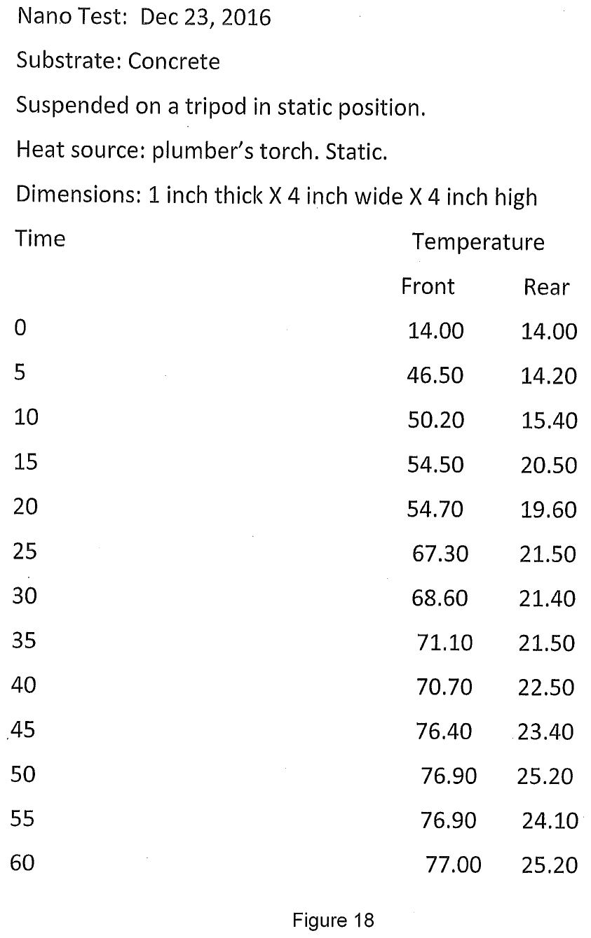

Turning to FIGS. 17 and 18, charts outlining temperature values obtained from a heat transfer experiment using a concrete block made with regular water (FIG. 17) and a concrete block made with nanobubble water (FIG. 18) are provided. For the experiment, the concrete blocks were not coated and the concrete was non-air entrained. A heat source was directed at the front surface during the pendency of the experiment.

As can be seen in FIG. 17, for the normal water concrete block, at time 0, the temperature at the front and rear of the block was measured at 7.10 degrees Celsius. Over time, the temperature of the front of the block rose slowly to 38.30 degrees Celsius after 60 seconds while the rear of the block rose to 37.90 degrees Celsius after 60 seconds. As can be seen in the chart, the temperature at the front and rear of the normal water concrete block remained somewhat identical over the duration of the experiment.

For the nanobubble water concrete block, the starting temperature measured at the front and rear of the block was slightly higher (at 14.00 degrees Celsius). During the experiment, the temperature measured at the front of the concrete block rose to 77.00 degrees Celsius over the 60 second period while the rear of the concrete block only rose to 25.20 degrees Celsius over the same time period.

From the results, it can be seen that an advantage of the nanobubble water concrete block is that it has an improved R-value over the regular water concrete block. R-value relates to the capacity of a material to resist heat flow such that the higher the R-value, the greater the insulting power. In other words, from the results, the nanobubble water concrete block can be seen as having a better insulating power than the regular water concrete block.

Another advantage of the nanobubble water concrete, or concrete block, is that for air entrained nanobubble water concrete, further benefits in R-value may be experienced. Also, in experiments, the concrete was still able to set even when excess nanobubble water was added to the concrete mixture.

It was also found that by applying nanobubble water to existing concrete blocks or pillars and the like, efflorescence problems were reduced or eliminated. In other words, the process for cleaning the existing concrete items to rid them of efflorescence was improved by first cleaning the existing concrete items with the nanobubble water. In this manner, it can be seen that the nanobubble water may be beneficial in possibly rehabilitating existing concrete items. Similarly, for concrete items which are produced using nanobubble water, the likelihood that efflorescence may form on these concrete items is reduced or eliminated.

In further experimentation, water at the point of entry of the water supply for a building was treated with a nonabubble solution producing apparatus 14 such that the water entering the building was transformed from regular water to nanobubble water. This nanobubble water was then circulated throughout the building for use in bathrooms, kitchens and anywhere else where the water supply is used. As the water evaporated within the building, such as, but not limited to, in the form of moisture or steam from cooking or showering, resultant tests showed that the energy required to heat the building was reduced. It is believed that the steam or moisture from the nanobubble water was integrated within the existing concrete walls of the building and therefore, provided an improved reflection of heat. In that manner, the improved reflection characteristics of the concrete walls assisted in maintaining the building at a predetermined temperature with less work from the boilers. Furthermore, it was found that there was a reduction in odors in the trash compactor.

Other advantages of the nanobubble water treated cement or concrete is that there is an increased oxidation-reduction potential (ORP) where harmful microbes are quickly killed thereby protecting the water itself, food products and surfaces from contamination. Another advantage is that any bio-film is either removed or and the likelihood that it forms is reduced thereby reducing or eliminating re-contamination, organic corrosion, improving quality and productivity and enhancing heat transfer in operations. A further advantage is a lower surface tension which may allow for a reduction in cleaning chemical usage and other surface active agents such as, but not limited to, retention aids, coatings defoamers, etc. In yet another advantage of the nanobubble water treated cement, an energy savings may be recognized whereby it takes less energy to pump the nanobubble water through the water supply system compared with traditional processed water.

In another embodiment of nanobubble water produced concrete, the concrete may experience an improved thermal insulation. The nanobubble water vapour or the nanobubble water concrete may also improve heat distribution. As such, the nanobubble water concrete walls may be seen as “heat sinks” to radiate heat when needed and reduce energy needs.

In some embodiments, within the nanobubble water concrete, cavitation bubbles may be formed. O⁻ can be captured within these bubbles and the free oxygen is then available for oxidation of other elements such as, but not limited to, Chlorine. The free electrons may also convert the water to have paramagnetic properties which may allow for the removal of scale or biofilm.

When using nanobubble water in the production of cement, the cement chemistry may be improved. For instance, the mixing and kinetics of the cement reaction may be improved, the curing times of concrete accelerated, the development of a strong uniform bond between the aggregate and the mortar and due to agglomeration caused by lower zeta potential, the cement cures uniformly reducing voids.

In another embodiment, the nanobubble water concrete may find benefit in sound attenuation. For instance, when nanobubble water produced concrete is used in the walls of a room or building, any sound energy that contacts the nanobubble water concrete wall may be absorbed into the concrete to improve sound attenuation.

The present disclosure describes various enhanced properties of concrete made using nanobubble water but one of skill in the art will understand that other properties may also be enhanced by use of the nanobubble water.

Other advantages of the nanobubble water concrete include, but are not limited to, a more wet cement consistency whereby the nanobubble water can be controlled of biofilms and molds, an improved cement consistency containing lower anaerobic bacteria counts; a longer expected lifetime, improved protection of parts from corrosion, such as rebars, and improved equipment maintenance.

While the above description provides examples of one or more apparatus, methods, or systems, it will be appreciated that other apparatus, methods, or systems may be within the scope of the claims as interpreted by one of skill in the art.

What is claimed is:

1. A method of producing concrete comprising:
producing a nanobubble solution;
mixing the nanobubble solution with sand, gravel and cement to produce a concrete mixture; and
curing the concrete mixture.

2. The method of claim 1 wherein producing a nanobubble solution comprises:
passing a liquid though a nanobubble solution producing apparatus.

3. The method of claim 2 wherein the liquid is water.

4. The method of claim 2 wherein passing a liquid comprises:
passing the liquid through a nanobubble generator.

5. The method of claim 4 wherein producing the nanobubble solution further comprises:
filtering the liquid prior to passing the liquid through the nanobubble generator.

6. The method of claim 5 further comprising:
treating the liquid after it has passed through the nanobubble generator.

7. The method of claim 1 wherein mixing the nanobubble solution with sand, gravel and cement comprises:
mixing sand and the nanobubble solution into a slurry;
adding gravel to the slurry; and
adding cement to the slurry.

8. The method of claim 7 further comprising adding more nanobubble solution to the slurry.

9. The method of claim 1 further comprising before mixing:
wetting a mixing vessel with the nanobubble solution.

10. An apparatus for producing concrete comprising:
a mixing vessel;
a nanobubble solution production apparatus for producing a nanobubble solution; and
at least one apparatus for providing concrete ingredients to the mixing vessel;
wherein the nanobubble solution and the concrete ingredients are mixed within the mixing vessel to produce concrete.

11. The apparatus of claim 10 wherein the at least one apparatus comprises:
a cement apparatus for providing cement to the mixing vessel.

12. The apparatus of claim 10 wherein the at least one apparatus comprises:
a sand apparatus for providing sand to the mixing vessel.

13. The apparatus of claim 10 wherein the at least one apparatus comprises:
at least one ingredient apparatus for providing the at least one ingredient to the mixing vessel.

14. The apparatus for claim 10 wherein the nanobubble solution production apparatus is a nanobubble water production apparatus.

15. The apparatus of claim 10 wherein the nanobubble solution production apparatus comprises:
a nanobubble generator.
